(19) United States
(12) Patent Application Publication
(10) Pub. No.: US 2022/0332513 A1
(43) Pub. Date: Oct. 20, 2022

(54) CARRYBACK ASSESSMENT MAT

(71) Applicant: Flexible Steel Lacing Company, Downers Grove, IL (US)

(72) Inventors: Carl Hessler, Rockford, MI (US); Ross Vander-Weide, Walker, MI (US)

(21) Appl. No.: 17/724,446

(22) Filed: Apr. 19, 2022

Related U.S. Application Data
(60) Provisional application No. 63/176,862, filed on Apr. 19, 2021.

(51) Int. Cl. B65G 43/08; B65G 45/12; B65G 45/26

(52) U.S. Cl. CPC B65G 43/08; B65G 45/12; B65G 45/26; B65G 2203/0258; B65G 2207/48

(57) ABSTRACT

A mat assembly is provided for receiving carryback material deposited from a conveyor belt. The mat assembly includes a substrate for deployment below the conveyor belt, and a plurality of discrete sensors mounted to the substrate. Each sensor of the plurality of sensors detects weight of the carryback material deposited on the substrate proximate the sensor. The mat assembly further includes a processor that is communicatively coupled with the plurality of sensors. The processor is configured to convey data indicative of carryback material sensed by the plurality of sensors.

### CROSS-REFERENCE TO RELATED APPLICATION

This application claims the benefit of U.S. Provisional Patent Application No. 63/176,862, filed Apr. 19, 2021, entitled CARRYBACK ASSESSMENT MAT, which is hereby incorporated by reference in its entirety.

### FIELD

This disclosure relates to conveyor systems and, more specifically, to monitoring carryback of a conveyor system.

### BACKGROUND

Conveyor systems are utilized to transport materials or objects from one position to another. One type of conveyor system is a conveyor belt system which may include a series of rollers and a conveyor belt arranged to travel thereover in a downstream belt travel direction and path. Conveyor belt systems may be used to transport different conveyed materials such as coal or aggregate.

During use, residue from the conveyed material can build up on a conveyor belt. The residue may include small particles and/or liquids that stick to the belt such that the residue remains in contact with the conveyor belt surface after the rest of the conveyed material is discharged from the belt.

Conveyor belt cleaners are used to remove such residue and debris as the conveyor belt moves along the travel path. In many instances, however, such conveyor belt cleaners may not remove all residue. For example, an improperly installed or misaligned belt cleaner may remove some but not all residue from the belt. Even properly installed and aligned belt cleaners have belt scraper elements that may wear down over time, resulting in increasingly more residue and debris traveling past the belt cleaner. Such accumulating residue and debris may be referred to as carryback.

Carryback may negatively affect performance of a conveyor belt. For example, carryback may build up on the belt, may create an undue amount of airborne dust, or may eventually fall from the belt, accumulating in piles under the belt. Carryback accumulating unevenly on the belt may cause belt mistracking which may result in material spillage and off-center loading of conveyor rollers and the bearings therefor. Conveyor belt mistracking can lead to shortened belt-life, increased labor costs, and unscheduled downtime. Furthermore, cleanup of carryback can be labor- and equipment-intensive, often requiring equipment or services such as loaders and vacuum trucks.

Carryback may be monitored to determine the condition or alignment of an upstream belt cleaner. Known monitoring methods for monitoring carryback include scraping carryback from a belt and weighing the scraped-off carryback. This includes positioning a scraping element and a receptacle adjacent a belt and manually weighing the carryback collected in the receptacle. This is a labor-intensive process that requires a user to approach the conveyor belt system to access and empty the receptacle, and requires additional maintenance such as replacing wear parts such as the scraping element over time.

### BRIEF DESCRIPTION OF THE DRAWINGS

FIG. 1 is a first perspective view of a carryback mat positioned below the return run of a conveyor belt.

FIG. 2 is a schematic view of the carryback mat with a first sensor array.

FIG. 3 is a schematic view of the carryback mat with a second sensor array.

FIG. 4 is a schematic view of a power and conversion unit for assessing carryback material on the carryback mat.

FIG. 5 is a schematic view of a computing device including a processor configured to convey information based on the weight of the carryback material detected by the sensors.

FIG. 6 is a network diagram illustrating wireless communication of the carryback mat and sensor modules by way of a wireless gateway and a cloud computing system.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

In accordance with one aspect of the present disclosure, a carryback mat is provided for monitoring a conveyor system. The carryback mat includes one or more sensors for detecting a characteristic of the carryback material received on the mat. The carryback mat can be quickly deployed at a desired location below the conveyor belt, such as at the head or tail pulley or along the return run, to automatically measure and report the weight of carryback accumulated on the carryback mat. The mat may be deployed, for example, in less than one minute below the conveyor belt system, and may be deployed while the belt is running. For example, the mat may be deployed on a generally horizontal surface such as a ground surface or table, or may be suspended in the air above the ground (e.g., via support poles) and below the belt.

The mat measures the weight of accumulating carryback using sensors such as pressure transducers that are mounted and secured to the mat, and more particularly, embedded between layers of the mat. The weight of the carryback material may be made available to a user in real-time, and may be stored such that a user may access historical carryback data. The measurement of accumulated carryback is passive in that it does not require direct contact with the belt and does not include moving parts.

The mat may be utilized or deployed during installation or adjustment of a conveyor belt system. For example, the mat may be positioned below a belt and may accumulate carryback during a first run of the belt for a first period of time. This accumulated carryback may be a baseline carryback reading. An operator may then make adjustments to the conveyor belt system such as installing, removing, or adjusting a cleaner. The operator may then operate the conveyor belt system such that the carryback mat accumulates carryback during a second run of the belt (which may be for the same period of time as the first run). The carryback accumulated on the carryback mat during the second run may then be compared to the baseline carryback reading such that the operator can assess or quantify the impact the previous adjustment made to the conveyor belt system. In one example approach, a conveyor belt cleaner is not yet installed on the conveyor belt system or is not actuated such that a scraper blade or blades of the conveyor belt cleaner is not in engagement with the belt during the first run, and is engaged with the belt during the second run. In another example approach, the scraper blades are in scraping engagement with the belt during the first run, and is moved out of scraping engagement with the belt during the second run. In still another example approach, the scraper blades of one belt cleaner are in scraping engagement with the belt during each of the first and second runs, and additional scraper blades of another belt cleaner are placed in scraping engagement with the belt downstream or upstream of the one belt cleaner and over the mat during one of the first and second runs.

The mat may be powered via a plug-in interface for connecting to a power grid, or may be battery operated. The mat may remain deployed or arranged below the belt when not in use, may be removed for periodic cleaning, or may be stored when not in use. Because the mat is flexible, the mat may be folded or rolled up for storage.

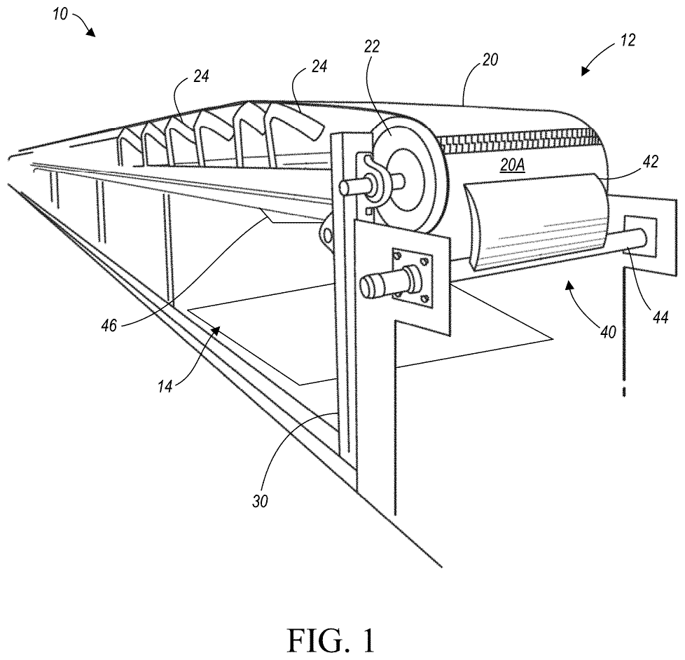

Referring to FIG. 1, a conveyor system 10 includes a conveyor belt assembly 12 and one or more carryback mats 14. The conveyor belt assembly 12 includes a conveyor belt 20 that extends across rollers such as drive roller 22 and idler rollers 24 that are rotatably supported by bearings mounted to a conveyor frame 30. The conveyor belt 20 is a continuous belt that extends around the drive rollers 20 and idler rollers 24 such that the conveyor belt 20 travels relative to the frame 30 along a path.

The conveyor belt system 10 further includes at least one belt cleaner 40. The belt cleaner 40 may include a scraper blade 42 biased toward the belt 20 so its upper scraping edge is urged into engagement with the outer surface 20A of the belt 20. The scraper blade 42 may be operatively mounted to an elongate support such as a support pole 44, which can be rotatively and/or linearly biased for causing the scraper blade 42 to tightly engage the outer surface 20A of the belt 20. In the approach shown in FIG. 1, the belt cleaner 40 is positioned proximate the head pulley or drive roller 22 so as to remove carryback material from the conveyor belt 20 as the belt 20 passes over the drive roller 22.

The carryback mat 14 may be a flexible mat that can be folded or rolled in a storage configuration, and unfolded or unrolled when deployed on a level or horizontal part of the ground below a conveyor belt assembly 12. In this way, the carryback mat 14 may be quickly installed below a belt 20, e.g., in less than one minute, without interfering with the operation of the conveyor belt assembly 12 for this purpose, as the carryback mat 14 need not be mounted to or directly contact any components of the conveyor belt assembly 12. In other words, the conveyor belt can continue running as the mat is deployed thereunder assuming it is done in a safe manner. In one approach, an operator may use a tool such as a pole or other elongate tool to assist in arranging the carryback mat 14 below the conveyor belt assembly 12 so that the operator can stay at a safe distance alongside the running belt.

In use, the carryback mat 14 may be positioned below the belt 20 along the return run of the belt 20 downstream of the belt cleaner 40. For example, the carryback mat 14 may be positioned on a floor surface under a secondary cleaner 46 that scrapes carryback from the belt 20. The carryback mat 14 may also be positioned below other features of the conveyor belt assembly 12 such as below drive roller 22 or idler rollers 24.

The carryback mat 14 may be of sufficient size such that the carryback mat 14 extends at least 50% of the width of the belt. For example, the carryback mat 14 may extend along a majority of the width of the belt 20 (e.g., along at least 75% of the width of the belt, along the entire width of the belt, or beyond the belt width). If the carryback mat 14 is sized to extend along the entire width, the peripheral edges of the carryback mat 14 may be arranged below the longitudinally-extending side edges of the belt 20.

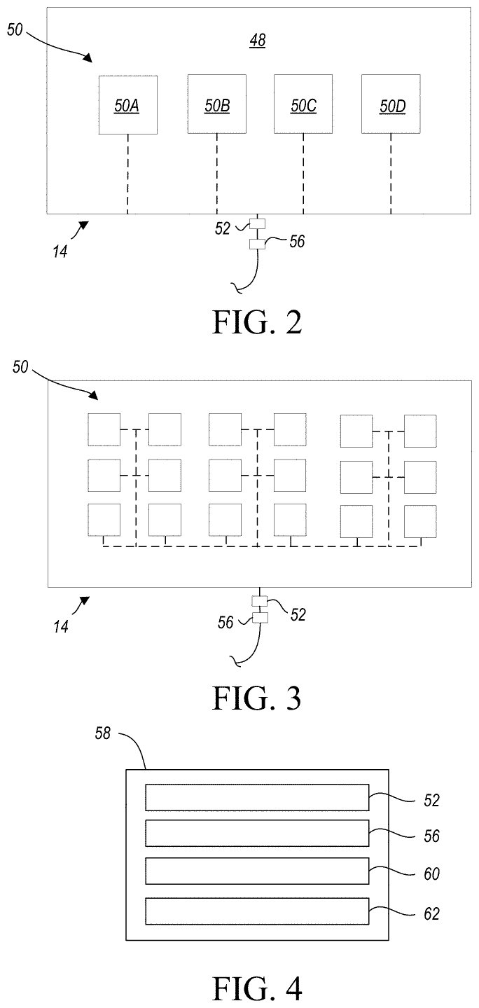

Referring to FIGS. 2 and 3, the carryback mat 14 may provide carryback information related to carryback material that is scraped from or otherwise falls from the belt 20 onto the carryback mat 14. The carryback mat 14 includes a flexible substrate 48 and one or more sensor modules or sensors 50 secured to the substrate 48. The sensors 50 may be flexible force sensors such as force transducers. The sensors 50 may be generally circular or quadrilateral in shape (e.g., square or rectangle). In one example, the sensors 50 are FlexiForce A502 Sensors sold by Tekscan, Inc.

The carryback mat 14 may include one sensor 50, or may include an array of sensors 50 having two sensors, three sensors, four sensors (as shown in FIG. 2), or more sensors (such as the 18 sensors shown in FIG. 3). The multiple sensors 50 allow for localized weight measurements along the width of the belt. In this way, the carryback mat 14 may provide localized carryback information identifying the location of the carryback as collected in the carryback mat 14. For example, a power and conversion unit 58 (discussed in greater detail below) may report that an outer sensor (e.g., 50A or 50D) accumulated a first amount of carryback, and that an inner sensor (e.g., 50B or 50D) accumulated a second amount of carryback that may be the same as or different than the first amount. Different feedback measurements across the sensors 50 may be indicative of wear of the cleaner blade at different locations therealong. For example, when an inner sensor 50B detects more carryback material than an outer sensor 50A, an operator may determine that the scraper blade 42 is worn down a greater extent near the outer portion of the blade 42 relative to a middle portion of the blade 42. Where the belt cleaner has multiple cleaner blades, then this would indicate that the outer blades are worn to a greater extent than the middle or inner blades. Additionally or alternatively, different feedback measurements across the sensors 50 may be indicative of imbalances or variations (e.g., “migration”) of carryback material across the width of the belt. In this way, a user may assess the carryback information to determine a corrective measure that can be taken for the conveyor belt assembly 12, which may include for example, replacing wear parts such as a scraper blade or blades, or can indicate undue wear of the belt cover at different locations across the width of the conveyor belt.

As shown in FIG. 3, the sensors 50 may be arranged in an array having sensors forming a plurality of rows and a plurality of columns. In this way, the sensors 50 can detect carryback material along a width of the carryback mat 14 (e.g., along the rows of the array of sensors) and along a length of the carryback mat 14 (e.g., along the columns of the array of sensors). By way of example, a first row of sensors may be positioned upstream of a scraper blade, and a second row of sensors may be positioned downstream of the scraper blade. In this example, the second row of sensors may detect more carryback material relative to the first row of sensors. Because the sensors 50 can detect carryback material along the width and length of the carryback mat 14, along with the weight of the carryback material (which may be indicative of a height of the carryback material), the sensors 50 may output signals indicative of a three-dimensional representation of the accumulation of carryback material on the carryback mat 14.

In another approach, the carryback mat 14 may also or instead include one or more bladders containing a gas or liquid. In this form, the sensor can be a pressure transducer that is operatively connected to the bladders to determine the force generated by the carryback on the bladders.

The substrate 48 of the carryback mat 14 may include at least two layers of flexible material secured together with the sensors 50 secured to either of the outer surfaces thereof such as an upper surface or a lower surface of the carryback mat 14. The mat layers may be formed, for example, of silicone rubber or other durable, flexible material. Preferably, the sensors 50 are secured between mat layers and the upper and lower surfaces of the carryback mat 14 to protect them from dirt and water, for example, often found in the industrial environment where many conveyor belt systems are typically installed. The layers of the substrate 14 may be adhered (e.g., glued) together with the sensors 50 therebetween. The adhesive may extend about each individual sensor 50 such that each sensor 50 has a substantially water-impermeable seal formed by the substrate 48 and adhesive that extends thereabout. In one approach, recesses or pockets are formed on an inner surface of one or both of the upper and lower layers of the substrate 48 to facilitate receiving and retaining individual sensors 50 therein. The recesses can be sized to reduce a thickness of the carryback mat 14 at the sensors 50 to reduce a height of the projections caused by the sensors 50. In the assembled form, the carryback mat 14 may have a thickness of approximately 1 inch at the sensors 50, and a thickness of approximately 0.5 to 0.75 inches at flat regions between the sensors. With the sensors 50 secured to the substrate 48, there are no moving parts associated with the sensors 50 and the substrate 48 of the carryback mat 14.

The carryback mat 14 includes a digital-to-analog circuit 52 that is connected to the sensors 50 to provide an output force reading indicative of the weight of the carryback material received on the carryback mat 14. As discussed in greater detail below, carryback material weight may inform an operator of an effectiveness of the scraper blade 42, and may be used provide an output such as a “cleanliness” score and/or amounts (e.g., weights) and locations of the carryback accumulated across the carryback mat 14. As discussed above, the amounts and locations of carryback material may be represented as a three-dimensional depiction. In this way, the carryback material may be assessed without the need for an optical camera.

The carryback mat 14 includes a power source 56. The power source 56, for example, may be in the form of a battery, which may be a rechargeable battery that has a charging interface. Alternatively, the power source 56 may include an electrical connector for connecting the carryback mat 14 to a shop power source. The power source 56 may be housed within a housing of a power and conversion unit 58 (discussed in greater detail below), a separate housing, or may be secured to or stored within the carryback mat 14.

Referring to FIG. 4, one or both of the digital-to-analog circuit 52 and the power source 56 may be housed within a power and conversion unit 58 that is connected to the carryback mat 14. The power and conversion unit 58 may also include a communication interface 60 such as a wired (e.g., Ethernet, LAN) or wireless (e.g., cellular, Bluetooth, or WiFi) interface. The power and conversion unit 58 may also include an electrical interface 62 for providing power to one or more components of the power and conversion unit 58.

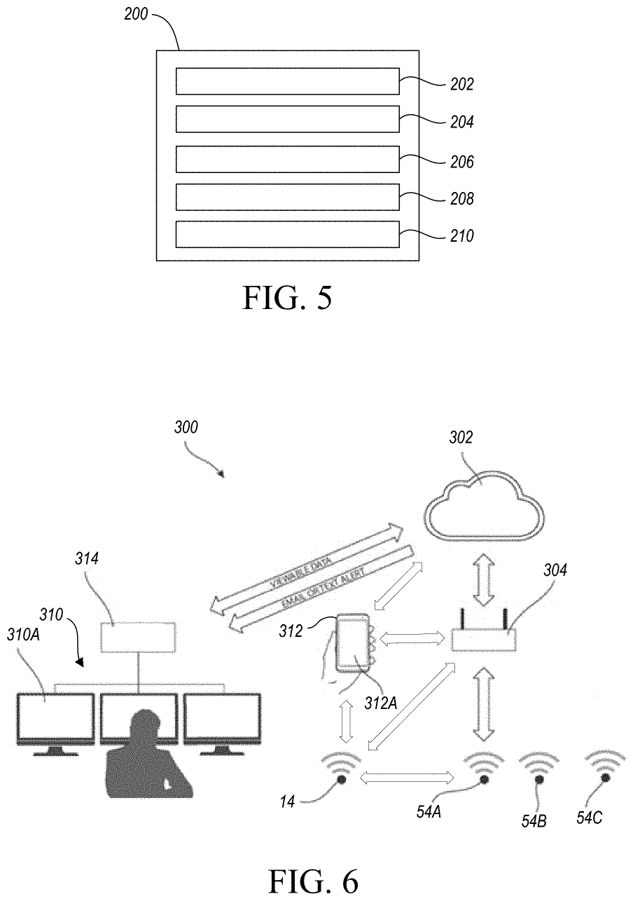

Referring to FIG. 5, a computing device 200 is shown. The computing device 200 may be a local computing device (e.g., located at or adjacent to the carryback mat 14) or may be a remote computing device that is communicatively coupled to the carryback mat 14. For example, the computing device 200 may be a cloud computing system 302, a computer 310, or a smartphone 312 as discussed in greater detail with respect to FIG. 6.

The computing device 200 includes a communication interface 202 for receiving data from the carryback mat 14 (e.g., from the power and conversion unit 58). The computing device 200 may also include a user interface 204, which may be in the form of a display such as a touchscreen display. In this way, the user interface 204 may display information pertaining to the carryback mat 14 and may receive user input; including, for example, belt width, belt speed, carryback collection duration, and the measured carryback weight.

The computing device 200 may further include a communication interface 206. The communication interface 206 may include an RF receiver, transmitter, or transceiver. The communication interface 206 may also or instead include a network interface such as a wired (e.g., Ethernet, LAN) or wireless (e.g., cellular, Bluetooth, or WiFi) interface for communicating over a network, such as the cloud computing system 302 discussed with respect to FIG. 6. In this way, the computing device 200 may communicate system information to remote devices such as computers or servers for remote (e.g., cloud) access, or user devices such as cellular phones having an application installed thereon.

The computing device 200 further includes a memory 208 that may store, for example, user inputs or system controls for the carryback mat 14. The memory 208 may also store historical carryback data, such as one day worth of data, one week worth of data, etc. The computing device 200 further includes a processor 210 operatively connected to one or more of the communication interface 202, user interface 204, communication interface 206, and memory 208 for executing commands at the computing device 200.

The computing device 200 is configured to report or convey carryback information to a user or operator. The amount of carryback may be expressed, for example, in lbs/ft² or gm/m², or may be expressed as a cleanliness score or three-dimensional depiction. In one example, the computing device 200 receives an accumulated weight at the sensors 50 from the carryback mat 14. The computing device 200 may convey a carryback weight detected over a predetermined duration (e.g., 10 minutes) of operation of the conveyor belt. The predetermined duration may be input at the computing device 200 (e.g., user interface 204 or the communication interface 206). After the predetermined duration, the computing device 200 is configured to determine and report an indication of carryback collected by the carryback mat 14 during the predetermined duration. For example, the computing device 200 may determine and/or convey a weight of the carryback material received on the carryback mat 14 as determined by sensors 50.

With the carryback information, the computing device 200 (e.g., via the processor 210) may determine a “cleanliness” of the belt 20. The computing device 200 may assign a value or grade to the carryback assessment, such as by a numerical range of, for example, 1-7 with a grade of 7 being the most clean. For example, the controller 200 may use one or more inputs (which may be inputted by a user), such as a belt width, belt speed, carryback collection duration, and the measured carryback weight to assess belt cleanliness. A cleanliness value of the belt can be determined as a function of the measured carryback weight so that the belt would be deemed to be cleaner when the carryback weight is lower since the conveyor belt presumably has less carryback material on it. However, this cleanliness value would also be impacted by at least one of the inputs. For example, assuming the measured carryback weight stays the same for two different conveyor belt operations, the computing device 200 may determine a first cleanliness score for a first conveyor belt operation that uses a first, relatively narrow belt, and may determine a second cleanliness score for a second conveyor belt operation using a wider belt. In this instance, the cleanliness value or score in the cleanliness scale for the second conveyor belt operation would be higher to reflect a cleaner conveyor belt than the conveyor belt of the first conveyor belt operation assuming the other inputs, i.e., belt speed and carryback collection duration, are the same between the conveyor belt operations. However, should the other inputs vary between the conveyor belt operations, then the scores of these conveyor belt operations could vary. Likewise, if the measured carryback weights between the two conveyor belt operations vary, the lower weight measurement would not necessarily generate a higher cleanliness value or score indicative of cleaner belt in that conveyor belt operation since the score would be impacted by the other inputs.

Referring to FIG. 6, the carryback mat 14 may be in communication with and monitored by a multipurpose conveyor monitoring system 300, such as the various systems disclosed in U.S. Pat. No. 10,836,585, which is incorporated by reference herein in its entirety. Such a multipurpose conveyor monitoring system 300 is able to monitor carryback on the carryback mat 14.

The monitoring system 300 may also monitor other sensor modules or sensors 54A, 54B, 54C associated with ancillary devices of the conveyor system such as splices and splice fasteners, belt scrapers, idler rollers, trackers, and/or impact beds. The sensors 54A, 54B, 54C include communication interfaces such as antennas and associated circuitry, or one of the various communication modules described above with respect to the communication interface 206 of the carryback mat 14. In some forms, the carryback mat 14 cooperates and communicates with one or more of the sensors 54A, 54B, 54C. For example, the carryback mat 14 may communicate information indicative of carryback material to one or more of the sensors 54A, 54B, 54C, which may then communicate the information to a cloud computing system 302, discussed in greater detail below.

The carryback mat 14 and sensors 54A, 54B, 54C communicate with the cloud computing system 302 by way of a gateway 304. The wireless communication between the gateway 304 and the carryback mat 14 and/or sensors 54A, 54B, 54C may utilize any of a variety of communication protocols. For example, the carryback mat 14 and/or sensors 54A, 54B, 54C may use infrastructure protocols such as 6LowPAN, IPv4/Ipv6, RPL, QUIC, Aeron, uIP, DTLS, ROLL/RPL, NanolP, CNN, and TSMP; identification protocols such as EPC, uCode, Ipv6, and URIs; communication/transport protocols such as Wifi, Bluetooth®, DigiMesh, ANT, NFC, WirelessHart, IEEE 802.15.4, Zigbee, EnOcean, WiMax, and LPWAN; discovery protocols such as Physical Web, mDNS, HyperCat, UpnP, and DNS-SD; Data protocols such as MQTT, MQTT-SN, Mosquitto, IMB MessageSight, STOMP, XMPP, XMPP-IoT, CoAP, AMQP, Websocket and Node; device management protocols such as TR-069 and OMA-DM; semantic JSON-LD and Web Thing Model; and/or multi-layer frame work protocols such as Alljoyn, IoTivity, Weave, and Homekit.

The cloud computing system 302 processes data from the carryback mat 14 to determine a characteristic of the carryback material received on the carryback mat 14. The cloud computing system 302 may also process data from one or more of the sensors 54A, 54B, 54C to determine one or more characteristics of a corresponding ancillary devices and/or conveyor belt 20, and/or to predict the remaining lifespan thereof. The cloud computing system 302 may also be operable to detect other statuses of the conveyor system 10, such as whether the conveyor belt 20 is running, how long the conveyor belt 20 has been running, how many times a splice has traveled about the conveyor system 10, whether the conveyor belt 20 is mistracking, whether an ancillary device is properly engaged with the belt 20, and the presence or absence of material on the conveyor belt 20. As is known, the cloud computing system 302 may include one or more remote servers providing cloud computing functionality.

Information from the cloud computing system 302 can be viewed by a user through a computer 310 or smartphone 312 via displays or user interfaces 310A, 312A thereof. The control system 314 may provide an operator information so that the operator can monitor or adjust the conveyor belt system 10 for proper operation thereof. The control system 314 may also allow an operator to provide inputs relating to the conveyor system 10 such as belt width, belt speed, cleaner type, carryback collection duration, and measured carryback weight. Although a desktop computer 310 and a smartphone 312 are shown in FIG. 6, other computing devices may be utilized such as a laptop computer, a tablet computer, a smartwatch, and augmented reality glasses. In this way, an operator may be informed of various characteristics of the conveyor system 10 such as a characteristic of carryback received on a carryback mat 14. The carryback information may be used, for example, to determine an imbalance in material being carried along the width of the belt 20.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. A carryback material collection assembly for receiving carryback material from a conveyor belt, the carryback material collection assembly comprising:
a substrate for deployment below the conveyor belt;
a plurality of discrete sensors mounted to the substrate, each sensor of the plurality of sensors configured to detect weight of the carryback material deposited on the substrate proximate the sensor; and
a computing device including a processor configured to convey information based on the weight of the carryback material detected by the plurality of sensors.

2. The carryback material collection assembly of claim 1 wherein the plurality of plurality of discrete sensors are arranged in an array so that there are a plurality of rows of the discrete sensors extending across the substrate and a plurality of columns of the discrete sensors extending perpendicular to the rows to provide a three-dimensional output of carryback material detected by the plurality of discrete sensors.

3. The carryback material collection assembly of claim 2 wherein the three-dimensional output of carryback material includes information regarding detected carryback material at different locations across a width of the conveyor belt via each of the rows of the discrete sensors, at different locations along a length of the conveyor belt via each of the columns of the discrete sensors, and information regarding an amount of the detected carryback material at the different locations across the width and the length of the conveyor belt.

4. The carryback material collection assembly of claim 1 wherein the plurality of sensors are arranged in an array across the substrate so that with the substrate deployed below the conveyor belt, the sensors receive carryback material from different corresponding locations across the conveyor belt so that each sensor measures the weight of carryback material received from the corresponding location of conveyor belt.

5. The carryback material collection assembly of claim 4 wherein the substrate is deployed below a belt cleaner having a cleaner blade extending across the belt and the weights measured by each sensor provide an indication of wear of the cleaner blade at different locations therealong.

6. The carryback material collection assembly of claim 4 wherein the measured weights by the plurality of sensors provides an indication of any imbalances of carryback material across the width of the belt.

7. The carryback material collection assembly of claim 1 wherein sensors are fixed to the substrate, and there are no moving parts associated with the sensors and the substrate.

8. The carryback material collection assembly of claim 1 wherein the sensors of the plurality of sensors are connected to a digital-to-analog circuit to provide an output force reading indicative of the weight of the carryback material deposited proximate the sensors.

9. The carryback material collection assembly of claim 1 wherein the substrate includes a first substrate layer and a second substrate layer, wherein the sensors of the plurality of sensors are positioned between the first and second substrate layers, and wherein the first substrate layer and the second substrate layer cooperate to form a substantially water-impermeable seal about each of the plurality of discrete sensors.

10. The carryback material collection assembly of claim 1 wherein the substrate is of a flexible material to allow the substrate including the sensors to be folded or rolled.

11. The carryback material collection assembly of claim 1 wherein sensors of the plurality of sensors include force transducers.

12. The carryback material collection assembly of claim 1 wherein the processor is configured to convey the information indicative of carryback material detected by the plurality of sensors to a remote computing device.

13. A method for assessing carryback material from a conveyor belt, the method comprising:
deploying a mat assembly below the conveyor belt;
detecting carryback material from the conveyor belt via a plurality of discrete sensors of the mat assembly; and
conveying carryback data to an operator indicative of the carryback material detected by the sensors.

14. The method of claim 13 wherein the mat assembly is configured to be deployed below the conveyor belt in less than one minute.

15. The method of claim 13 further comprising storing the mat assembly in a rolled or folded configuration out from below the conveyor belt, and
wherein deploying the mat assembly below the conveyor belt comprises unrolling or unfolding the stored mat assembly.

16. The method of claim 13 further comprising:
arranging each the plurality of discrete sensors at different locations across the mat assembly; and
wherein detecting the carryback material by the plurality of discrete sensors includes detecting weight of the carryback material via the plurality of discrete sensors to assess an imbalance in carryback material at different locations across a width of the conveyor belt.

17. The method of claim 13 wherein conveying carryback data indicative of carryback material includes conveying a value representative of a cleanliness level of the conveyor belt.

18. The method of claim 17 wherein the value representative of a cleanliness level is based on a weight of the detected carryback material and at least one of:
a belt width;
a best speed; and
a carryback material collection duration.

19. The method of claim 13 wherein amounts and locations of carryback material are conveyed as a three-dimensional representation.

20. The method of claim 13 further comprising:
receiving first localized carryback data indicative of carryback material sensed at a first sensor; and
receiving second localized carryback data indicative of carryback material sensed at a second sensor, the second localized carryback data indicative of carryback material different than carryback material sensed at the first sensor.

21. The method of claim 13 wherein the detecting of carryback material comprises:
detecting carryback material received on a mat assembly during a first conveyor belt operation; and
detecting carryback material received on the mat assembly during a subsequent second conveyor belt operation; and
determining a difference in the detected carryback material received on the mat assembly during the first and second conveyor belt operations.

22. The method of claim 21 wherein during the first conveyor belt operation, a belt cleaner is either not installed or disengaged from the conveyor belt, and during the second conveyor belt operation, the belt cleaner is installed or engaged with the conveyor belt.

23. The method of claim 13 further comprising:
assessing carryback material for a predetermined period of time; and
in response to expiration of the predetermined period of time, conveying information indicative of carryback material assessed during the predetermined period of time.
